(19) United States
(12) Patent Application Publication
(10) Pub. No.: US 2026/0300448 A1
(43) Pub. Date: Oct. 1, 2026

(54) Modular Computing with License Compliance

(71) Applicants: Eric Shi, Saratoga, CA (US); Niu Shi, Hangzhou (CN)

(72) Inventors: Eric Shi, Saratoga, CA (US); Niu Shi, Hangzhou (CN)

(21) Appl. No.: 19/094,928

(22) Filed: Mar. 30, 2025

(51) Int. Cl. G06F 21/10

(52) U.S. Cl. CPC G06F 21/107

(57) ABSTRACT

A modular computing method includes obtaining a software package, wherein the software package includes code segments and data segments; searching the code segments and data segments for license information; obtaining license information of the code segments and data segments; generating code modules and datasets from the code segments and data segments; attaching snippets to the code modules and datasets; and forming snippet-attached modules and snippet-attached datasets from the code modules and datasets. Each of the snippet-attached modules and snippet-attached datasets includes a corresponding snippet. The snippets make the snippet-attached modules executable, and the snippet-attached datasets become formatted and/or repackaged, respectively.

### FIELD OF INVENTION

This invention generally relates to computing and, more particularly, to modular computing and modular computing with license compliance.

### BACKGROUND

Traditional software distribution methods rely on monolithic programs, where components and functions are tightly integrated into a single system. While modular programming has been widely adopted in the computer industry, its primary focus has been on improving development efficiency, maintainability, and scalability. Modularization in conventional software primarily addresses software structures, software development, and maintenance convenience rather than concerns such as security, privacy, and license compliance. By breaking software into reusable code, functions, scripts, packages, and libraries, modularization enhances reliability and reusability.

The rise of open-source software has provided developers with access to an extensive ecosystem of training datasets, algorithms, tools, and digital assets, including 3D models, modeling programs, and remixing tools. While these resources accelerate innovation and development, their integration with proprietary data and software introduces significant challenges, particularly concerning security, privacy, and license compliance.

One of the most pressing issues in combining open-source and proprietary assets is licensing complexity and compliance management. Open-source projects often come with varying usage restrictions, licensing obligations, and attribution requirements. In early-stage development, evaluating and experimenting with open-source resources may seem harmless. However, as a project progresses, the effort required to identify, replace, or separate technical debts—such as improperly licensed components—can be substantial. Failing to address these issues in a timely manner exposes software to legal risks, intellectual property disputes, and potential financial liabilities throughout its entire lifecycle.

Beyond licensing concerns, deploying proprietary intellectual property (IP) and sensitive assets in cloud environments-whether for research, testing, or production-raises serious questions about data security and privacy. Cloud-based solutions often introduce additional risks, including high network latency, increased operational costs, and exposure to unauthorized access. For example, developers and engineers working with 3D data and algorithms frequently encounter difficulties in testing and debugging models locally due to the lack of robust local computing support. The reliance on cloud-based computing environments further complicates control over sensitive information and exposes critical assets to third-party infrastructures.

Furthermore, there is a lack of unified tools that enable seamless integration and management of open and private resources while allowing flexibility in switching between different computing environments. Developers need a secure, adaptable framework that supports both local and cloud-based computation without compromising efficiency, privacy, security, or compliance.

The present invention has been made to solve the problems set forth above and other related issues.

### SUMMARY OF THE DISCLOSURE

In accordance with the present disclosure, a modular computing method includes obtaining a software package, wherein the software package includes code segments and data segments; searching the code segments and data segments for license information; obtaining license information of the code segments and data segments; generating code modules and datasets from the code segments and data segments; attaching snippets to the code modules and datasets; and forming snippet-attached modules and snippet-attached datasets from the code modules and datasets. Each of the snippet-attached modules includes a corresponding snippet. The snippets make the snippet-attached modules executable and the snipped-attached datasets be repackaged into one of predetermined formats including Zip, GLB, Parquet, etc.

In another aspect of the present disclosure, a modular computing method includes obtaining a task; selecting code modules and datasets, wherein at least a majority of the code modules and datasets each include a snippet, and the snippet makes a code module of the at least a majority of the code modules and datasets executable or makes a dataset of the at least a majority of the code modules and datasets formatted and/or repackaged; grouping the code modules and datasets according to license information; and executing the task using the code modules and datasets.

In yet another aspect of the present disclosure, a modular computing system includes an execution unit for executing a task, a data storage and management unit, a content management system (CMS) unit, code modules, and datasets. The code modules and datasets include snippets, respectively. The snippets make at least part of the code modules executable. The snippets make at least part of the datasets repackaged and/or formatted.

Other aspects or embodiments of the present invention can be understood by those skilled in the art in light of the description, claims, and drawings of the present disclosure.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is a block diagram illustrating a modular computing system in accordance with the present disclosure.

FIG. 2 is a block diagram illustrating the modular computing system shown in FIG. 1 with more details in accordance with the present disclosure.

FIG. 3 is a block diagram illustrating a process to generate discrete modules and datasets in accordance with the present disclosure.

FIG. 4 is a block diagram illustrating discrete modules and datasets with license status in accordance with the present disclosure.

FIG. 5 illustrates a flow chart describing generation of snippet-attached modules and snippet-attached datasets in accordance with the present disclosure.

FIG. 6 illustrates a license compliance graph in accordance with the present disclosure.

FIG. 7 illustrates license selection trees in accordance with the present disclosure.

FIG. 8 illustrates a flow chart for executing a task in accordance with the present disclosure.

FIG. 9 illustrates a block diagram of module and dataset groups based on license in accordance with the present disclosure.

FIG. 10 illustrates a block diagram of module and dataset groups based on license strictness in accordance with the present disclosure.

FIG. 11 illustrates a block diagram of module and dataset groups based on computing environment in accordance with the present disclosure.

### DETAILED DESCRIPTION

The following list of embodiments are provided for complete disclosure of the present invention and to fully inform the scope of the present invention to those skilled in the art. The present invention is not limited to the schematic embodiments disclosed, but can be implemented in various types. Furthermore, embodiments provided in this disclosure may be combined when there is no contradiction or conflict. The same reference numbers are used throughout the drawings to refer to the same or similar parts.

The present disclosure provides a unified, modular execution framework that allows secure, efficient, and license-compliant computing across local devices and cloud environments. By introducing a structured approach to modularized data and programs, embodiments of the present disclosure enhance software research, development, testing, and production workflows, while mitigating risks associated with intellectual property protection, licensing complexity, and computational resource optimization. The present invention is applicable to a wide range of fields, including 3D geometry computing, artificial intelligence, and enterprise-level production management.

The present disclosure introduces a new dimension to modularization, extending beyond code organization to focus on the secure and legitimate management of both programs and data. A modularized computing framework is proposed that improves data protection, licensing integrity, and operational flexibility. It efficiently manages and executes computational workflows while safeguarding intellectual property.

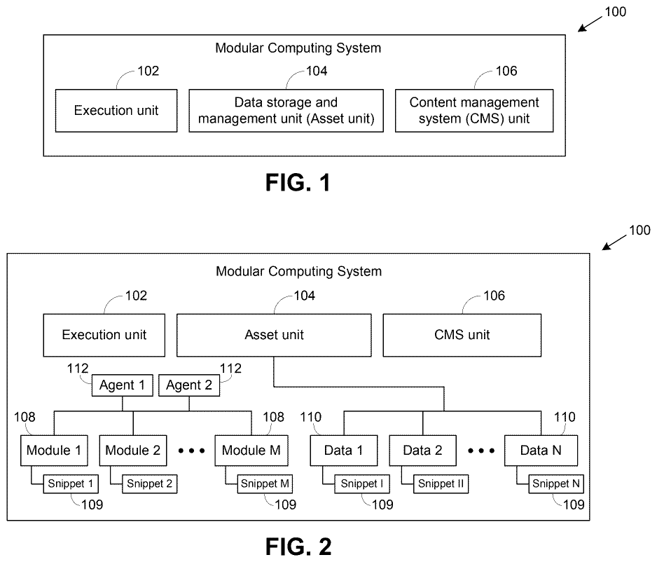

FIG. 1 is a block diagram illustrating a modular computing system 100 according to embodiments of the present disclosure. In some embodiments, the modular computing system 100 includes an execution unit 102, a data storage and management unit 104, and a content management system (CMS) unit 106. The data storage and management unit 104 may also be referred to as an asset unit 104. Each of the computing units 102-106 works independently and each may be hosted either locally (e.g., at a personal computer) or remotely (e.g., in the cloud). Optionally, at least one of the computing units may also be virtual, utilizing shared hardware resources. In some embodiments, the three computing units may reside at the same device (e.g., the same personal computer or same server) for optimal performance. In some other embodiments, the computing units may be distributed across multiple devices to benefit from enhanced storage, scalability, license compliance, and other advantages.

The execution unit 102 serves for computing executions (e.g., executing a task) and is capable of running either locally or in the cloud. The execution unit may be equipped with a proxy agent to facilitate communication and manage executions of code modules. As used herein, the terms “code module” and “module” have the same meaning and are exchangeable. A code module or module may be referred to as a discrete, independently manageable unit of program that can be executed, linked, or integrated into broader software systems. A module may be derived from a code segment or a library of a monolithic software package. Modules may be used to enable modular computing and flexible licensing. For example, a module may operate under its own licensing terms, such as a proprietary license, an MIT license, or a GNU general public license (GPL). A module may behave like a normal program, but have very few or no options if it runs in a command line mode or in an interactive GUI mode between a user and a device, or between devices. In addition, modules may include static and dynamic libraries. A module may be executed at a local computer or in the cloud. The selection of local or cloud-based execution environment may be determined based on the computational needs, licensing restrictions, and efficiency considerations of the software.

As used herein, the terms “execution environment”, “running environment”, and “computing environment” have the same meaning and are exchangeable. Exemplarily, these terms may indicate a combination of computer hardware, software, networks, and services arranged for software programs and service. In some cases, local executions may be preferable for prototyping and development, as it allows for more flexible combinations of modules and data. Cloud-based executions, on the other hand, may be more suitable for production deployments where scalability and resource availability may better align with licensing requirements.

The asset unit 104 functions as a secure storage and management unit for various data resources, such as three-dimensional (3D) models, artificial intelligence (AI) training data, and test data, which may be referred to as assets. Assets in the asset unit 104 may be subject to or governed by different license types, such as proprietary licenses, open-source (including copyleft and permissive) licenses, and subscription-based licenses. Open-source licenses include MIT license, BSD license, Apache license, GPL, Creative Commons, etc. The asset unit 104 may contain multiple data sources, each of which has its own licensing constraints. The system 100 is arranged such that the assets are securely stored while remaining accessible for computational tasks. The assets may be stored locally for enhanced security and rapid accessibility. At least part of the assets may also be stored in the cloud for scalability and distributed computing.

The functions of the CMS unit 106 include storage and management of metadata, such as file names, data attributes, and licensing information. Optionally, the CMS unit 106 may not keep data that is private or sensitive. In some embodiments, the CMS unit 106 may operate in a networking environment to manage resource allocation, ensure license compliance, enforce patent rights, and efficiently handle computing resources. In some cases, the CMS unit 106 may also be deployed at a private infrastructure to meet specific security and operational needs. Optionally, the CMS unit 106 may incorporate various modules and data from both external software communities and in-house developments, facilitating seamless integration and management.

FIG. 2 is a block diagram illustrating the modular computing system 100 shown in FIG. 1 with more details according to embodiments of the present disclosure. Exemplarily, the system 100 may further include M modules 108 and N datasets 110, such as module 1, module 2, module M, Data 1, Data 2, and Data N. As used herein, the term “dataset” may be referred to as a structured collection of data. Optionally, the system 100 may further include snippets 109 that are provided with the modules 108 and datasets 110, respectively. Snippets 109 included in or attached to modules 108 may be referred to as code snippets, such as code snippets 1, 2, and M. Snippets 109 included in or attached to datasets 110 may be referred to as data snippets, such as data snippets I, II, and N. A code snippet may be referred to as a small and reusable piece of software or code. A code snippet may perform a specific function or task to enable execution of certain software. In some cases, a code snippet may function as an execution wrapper that wraps a software file or code segment and makes the software file or code segment executable. A data snippet may be referred to as a small and reusable piece of information. A data snippet may repackage or reformat data to satisfy computing requirements. As used herein, the term “snippet” may indicate either a code snippet or a data snippet, while the term “snippets” may indicate code snippets and/or data snippets.

As shown in FIG. 2, snippets 1 and 2 are arranged for modules 1 and 2, while snippets I and II are arranged for datasets 1 and 2, respectively. The modules 108 are controlled by the execution unit 102, while the datasets 110 are managed by the asset unit 104. In some embodiments, the execution unit 102 may include at least part of the modules 108 and the asset unit 104 may include at least part of the datasets 110. Optionally, the modules 108 and datasets 110 may be arranged at a local computer. Alternatively, the modules 108 and datasets 110 may be arranged in the cloud. In some cases, the modules 108 and datasets 110 may be hosted partially locally and partially in a cloud-based environment.

As aforementioned, the system 100 may be operated in a local or cloud-based environment. For example, a personal computer may serve as a representative device that hosts the modules 108 and datasets 110. Such a local computing setup may be configured when security and privacy protection need to be enhanced, as it enables users to maintain full control over proprietary assets and sensitive computations without external exposure. Additionally, the local execution provides efficiency advantages by reducing network latency and avoiding unnecessary cloud processing costs.

While the modules 108 may be discrete, self-contained, and executable software units, the datasets 110 may be discrete, self-contained, and well-formatted. The snippets 109 may be configured individually to wrap the modules 108 and datasets 110, respectively. In some embodiments, the snippets 109 may have execution functions such as C++ main( ) functions to implement initiation and execution. In some cases, a snippet 109, e.g., a code snippet 2, may be attached to a module 108 and make the module binary executable on top of a computer operating system or via a Python environment. Similarly, a snippet 109, e.g., a data snippet II, may be attached to a dataset 110 and make the dataset become repackaged, formatted, accessible, and functional on top of a computer operating system or via a Python environment.

Further, the modules 108 and datasets 110 may be distributed across cloud resources for parallel execution. The cloud deployment model may be advantageous for large-scale computations that require significant processing power, high availability, and scalability. When the software execution is modularized in the cloud, it may enhance flexibility, optimize resource allocation, and improve compliance with licensing requirements while leveraging the benefits of distributed computing.

In some embodiments, the system 100 may further include proxy agents such as agent 1 and agent 2 depicted in FIG. 2. Optionally, agents 1 and 2 may be included in and controlled by the execution unit 10. In addition, agents 1 and 2 may communicate and share metadata and other information with the CMS unit 106. The CMS unit 106 may use the agents to allocate the modules 108 and datasets 110 while ensuring security, privacy, and license compliance. This coordination is essential for managing execution operations either locally or in a cloud-based environment. By utilizing the agents, the system 100 may dynamically optimize the use of available resources, and execute tasks in an efficient and compliant manner. The system 100 not only enhances computational efficiency but also provides a robust framework for managing various licensing models and protecting intellectual property. The system 100, with a modular architecture and license compliance mechanism, may enable seamless integration of diverse software components, thereby reducing the complexity of software deployment and maintenance.

In some embodiments, agents 1 and 2 may use scripting languages, such as Python, to execute the modules 108 using operating system (OS) commands. Optionally, the modules 108 may operate in a pipeline fashion, where the modules 108 may share input and output results through various OS storages. In some other embodiments, the modules 108 may run in parallel to speed up execution, where additional OS commands may be required for data integrity. In some cases, the modules 108 may also be executed using a graph model to facilitate more complex downstream and upstream communications.

For some tasks, such as 3D model recoloring, mesh engraving, or AI data preparation, there is a need to locate appropriate modules and datasets. Traditional software packages often rely on monolithic applications where all software components are tightly coupled, deployed together, and integrated into a single program. The monolithic application makes it difficult to use open-source programs that may require strict permission for commercial distribution of proprietary software.

In some embodiments, a code snippet may include clear metadata information, simple instructions for usage, and automated checking scripts. Metadata describes elements such as version numbers and execution environment details. It may help the CMS unit 106 and agents 112 manage and check if modules are compatible or if they need updates.

In some embodiments, code snippets may be arranged to adapt to the computing environment. For example, a code snippet may contain code that detects runtime details, such as software library versions, the operating system type, and certain hardware information. When the code of the code snippet runs, it may adjust functions, memory management, or parallel processing strategies to match the detected environment. It may reduce the need for manual code adjustments.

In some embodiments, a code snippet may contain built-in licensing rules and tracking abilities. The snippet may contain logic to enforce usage restrictions, log where and how it's being used, and provide a unique digital ID for tracking changes across different projects. It may help a user manage open-source licenses and track unauthorized or outdated snippet use.

In some embodiments, a data snippet may include a built-in data conversion layer. The data snippet may be packaged in common formats like JSON or XML and include scripts that parse and map data. The data snippet may help users use data more efficiently.

In some embodiments, a data snippet may include incremental version updates. The data snippet includes an initial dataset and smaller “update” files that show only recent changes. When the data snippet is deployed, it enables the CMS unit, agents, or modules to decide whether the running environment needs a full dataset download or just smaller incremental updates. It may avoid redundant computing, reduce bandwidth use, and track dataset changes over time.

In some embodiments, a data snippet may include a small AI component that generates additional data if there is a need. For example, if a module detects certain categories lack enough data, the data snippet may create or suggest additional synthetic data. It may keep datasets balanced and effective even as situations change.

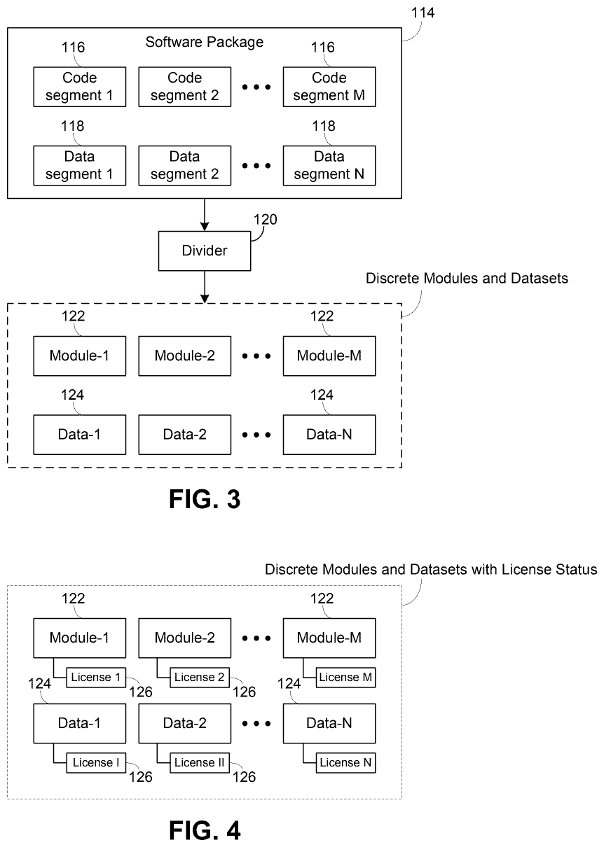

FIG. 3 is a block diagram illustrating a process to generate discrete modules and datasets according to embodiments of the present disclosure. Assuming a software package 114 is a monolithic application or library that contains components like code segments 116 and data segments 118. The code segments 116 are software files, and the data segments 118 are data files. The software files may include libraries. As used herein, the term “data segment” may be referred to as information that can be stored, processed, and transmitted digitally. Because the code segments 116 and data segments 118 are tightly coupled and deployed together in a monolithic structure, if there is a need to replace a component, e.g., a code segment 1, it might be difficult to do it. The situation becomes more complex and difficult when the code segment is open-source software with strict permission for commercial distribution.

As shown in FIG. 3, a divider 120 is arranged to decompose the software package 114. In some embodiments, the divider 120 may be included in a modular computing system, such as the system 100 illustrated above. The divider 120 may scan the software package 114, identify the code segments 116 and data segments 118, and decompose or divide the software package 114 to separate the code segments and data segments from the package. The divider 120 may be used to scan certain code and data iteratively and recursively. In addition, a manual process may also be used to divide the software package 114. The software package 114 may be broken down into smaller modular units, i.e., the code segments 116 and data segments 118. Further, the code segments 116 and data segments 118 are transformed into modules 122 and datasets 124, respectively. For example, code segments 1, 2, M are respectively transformed into module-1, module-2, and module-M, and data segments 1, 2, and N are respectively converted into data-1, data-2, and data-N. The modules 122 and datasets 124, with snippets attached, are discrete, self-contained, executable, and operate independently. A module 122 or dataset 124 may be easily replaced when licensing issues arise. For example, when a module 122 or dataset 124 needs to be replaced, this module or dataset may be removed and replaced directly, while other modules or datasets are not affected. It limits the adjustment to one component of the software package. After the modules 122 and datasets 124 are generated, the original software package 114 is changed into a new software package that contains the modules 122 and datasets 124, instead of the code segments 116 and data segments 118. Each module and dataset may be designated for specific usage as well as certain licenses, making the modules and datasets easy for reuse and maintenance and have more benefits. The transformation process may be conducted by the system 100 or the CMS unit 106 of the system 100.

The modules 122 may be structured as binaries or scripts, depending on the level of code accessibility, licensing stipulations, and computational preferences. As the modules 122 are discrete and independent, a security-sensitive task may operate in an isolated environment, thereby mitigating the risk of unauthorized data access or breaches. Further, there are various ways to generate the modules 122 from the code segments 116. The modules 122 may be developed and/or compiled to fit different operating systems.

Referring back to FIG. 2, the modules 108 and datasets 110 may have the same characteristics as or similar characteristics to that of the modules 122 and datasets 124. The system 100 may enforce license compliance by distinctly separating open-source components from proprietary components. In some embodiments, the system 100 may dynamically replace either a module 108 or a dataset 110 to meet legal compliance requirements when the execution environment changes, such as from an internal development to a public deployment scenario. The system 100 may maintain regulatory compliance and detect whether software operations remain lawful and efficient regardless of the context.

FIG. 4 is a block diagram illustrating discrete modules and datasets with license status according to embodiments of the present disclosure. Optionally, the system 100 may further include a license file parser (not shown). The license file parser may be provided with the divider 120 shown in FIG. 3 in some cases. The license file parser may read license files associated with the modules 122 and datasets 124 and obtain the license status 126 of each component, as shown in FIG. 4 schematically. The license status 126 may contain a license indicator such as a name of the license. In some cases, license statistics of the modules and datasets may be presented in a table format by the system 100. In Table 1 for example, the #3 dataset has a name “Texture Image”, Creative Commons Zero (CC0) license, and is cloud-based open-source software. In Table 2 for example, the #5 module has a name “Hole Fillings”, a proprietary license, and is hosted at a personal computer.

TABLE 1
License Statistics of Datasets
Dataset

| | | | | |
|---|---|---|---|---|
| ID | Name | License | URI | Other Attributes |

| | | | |
|---|---|---|---|
| 1 | 3D Model 1 | Trade Secret | PC |
| 2 | 3D Model 2 | Proprietary | Cloud S3 |
| 3 | Texture Image | CC0 | Cloud |
| 4 | 3D LLM | MIT | Cloud S3 |

TABLE 2
License Statistics of Code Modules
Code Modules

| | | | | |
|---|---|---|---|---|
| ID | Name | License | URI | Other Attributes |

| | | | |
|---|---|---|---|
| 1 | Converter 1 | Proprietary | PC |
| 2 | GLB | BSD | PC |
| 3 | 3MF | BSD | PC |
| 4 | Remeshing | GPL | EC2 |
| 5 | Hole Fillings | Proprietary | PC |

The CMS unit 106 of the system 100 may organize the modules and datasets according to their license status to facilitate license compliance of data and programs. The CMS unit 106 may maintain a predefined license compliance graph based on standards of the software industry. When a new module or dataset is added to the system 100, the CMS unit 106 may update the license compliance graph to include any new license introduced.

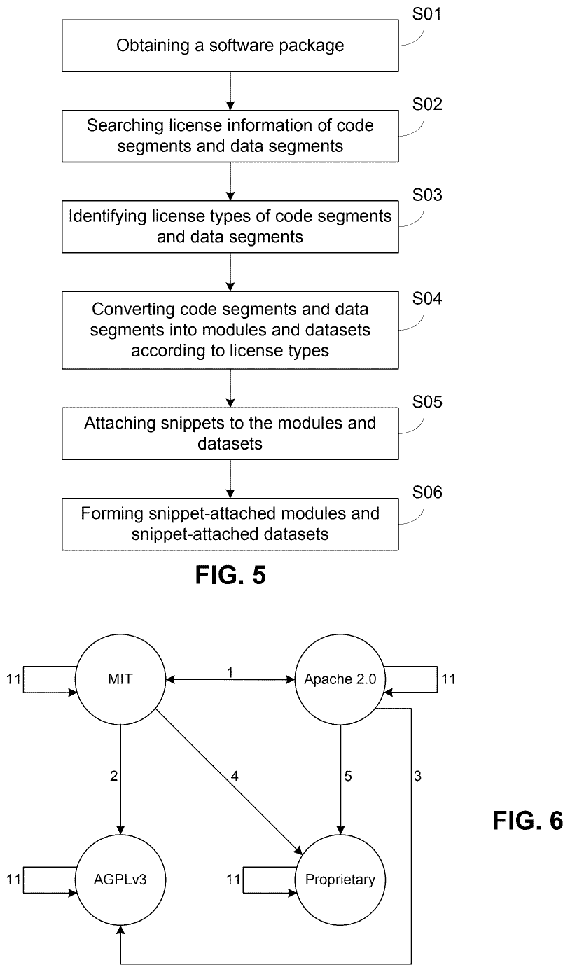

FIG. 5 schematically illustrates a flow chart describing a process to generate snippet-attached modules and snippet-attached datasets according to embodiments of the present disclosure. At S01, the system 100 obtains a software package. The software package contains open-source software including open-source files, libraries, certain data sources, proprietary software, and proprietary data.

At S02, the system 100 may search license information or license description in the software package. For example, files such as LICENSE.md, LICENSE.txt, or LICENSE.rst may be parsed to retrieve licensing information associated with open-source software. Additionally, copyright notices may be embedded directly within source code files or data files. Further, the software package may be divided into code segments and data segments according to license compliance status.

At S03, the system 100 identifies and obtains license types of the code segments and data segments. License types, such as MIT, GPL, proprietary, may be recognized. As such, license types of the code segments and data segments are obtained, respectively. Further, the system 100 separates or decomposes the software package into the code segments and data segments.

At S04, the system 100 converts the code segments and data segments into modules and datasets. That is, the system 100 generates the modules and datasets from the code segments and data segments. For example, the system 100 may generate a module with certain license compliance from a code segment with the same compliance and generate a dataset with certain license compliance from a data segment with the same compliance. Alternatively, the system 100 may also detect license strictness of the code segments and data segments, separate the code segments and data segments from the software package based on the license strictness, and then generate the modules and datasets accordingly. The license strictness may indicate whether it is permissive license, weak copyleft, or strong copyleft.

At S05, the system 100 generates snippets for the modules and datasets. Then, the system attaches the snippets to the modules and datasets, respectively. In some embodiments, the system attaches the snippet to each module and each dataset. Optionally, the system may attach the snippets to the majority of the modules and datasets, e.g., at least more than 50% of the modules and at least more than 50% of the datasets. As aforementioned, the snippet is configured to wrap and/or compile the code of the module or dataset into executable code or formatted data on top of an operating system (e.g., Windows, Linux, or Mac).

At S06, the system 100 changes the modules and datasets into snippet-attached modules and snippet-attached datasets. The snippet-attached modules and snippet-attached datasets each contain a corresponding snippet that is included at or attached to the module or dataset. While the code segments and data segments in the software package are not independently executable, the snippet-attached modules are independently executable and may be removed or replaced directly, and the snippet-attached datasets are controlled independently, directly accessible, and may also be removed or replaced directly when needed.

FIG. 6 exemplarily illustrates a license compliance graph according to embodiments of the present disclosure. Assuming the graph contains four license types that include MIT, Apache 2.0, AGPLv3, and proprietary license. The licenses are interlinked by paths. The arrow on a path indicates a compliance or combination direction. Path 1 connects MIT with Apache 2.0 with two arrows pointing to both licenses. The two arrows of path 1 indicate MIT licensed code may be combined with an Apache 2.0 project, and Apache 2.0 licensed code may be combined with an MIT project. MIT is a permissive license that may be reused in not only Apache 2.0 but also AGPLv3 and proprietary code. The latter two scenarios are reflected by paths 2 and 4. Path 3 indicates Apache 2.0 is compatible with GPLv3 and AGPLv3 (in broad terms). After Apache 2.0 code and AGPLv3 code are combined, the combined code is under AGPLv3 copyleft. Path 5 indicates Apache 2.0 code is compatible with a proprietary program, but proprietary code is not compatible with an Apache 2.0 application. The license compliance graph further includes paths 11 that are attached to each license. Path 11 may be used to indicate code files or applications with the same license or license compliance may be combined. In some cases, licensing permissions may be complicated by patent regulations or specific clauses—for instance, those found in the Apache 2.0 license.

TABLE 3
Module and Dataset Compliance Relationship

| Name | Module | Dataset | Other Attributes |
|---|---|---|---|
| Compliance 1 | 1 | 1 | |
| Compliance 2 | 1 | 2 | |
| Compliance 3 | 2 | 3 | |
| Compliance 4 | 3 | 4 | |

Table 3 shows exemplary relationships between modules and datasets that may be used to facilitate license compliance processes. If a module and a dataset share the same or compatible license compliance requirements, they may be considered as a compatible pair. For example, as module 2 and dataset 3 each meet the requirement of compliance 3, the two components may form a pair and bundled together. The relationships as shown in Table 3 may be used to query the CMS unit 106 based on a computing case and available computing environment. The system 100 may use Table 3 to make dynamic adjustments to maintain compliance when the execution context changes. It may improve both legal adherence and operational efficiency.

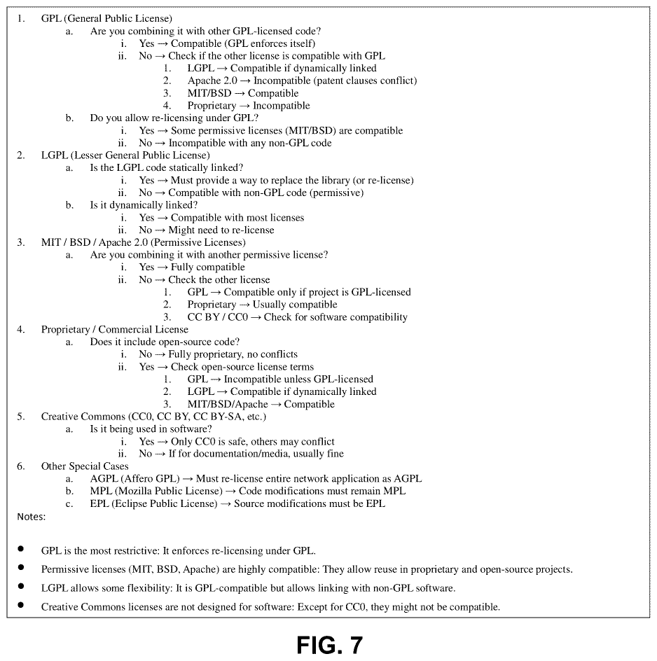

FIG. 7 illustrates exemplary license selection trees according to embodiments of the present disclosure. The license selection trees may be generated by the CMS unit to facilitate the search and verification of license compatibility for modules and datasets. Six license selection trees are presented exemplarily. After a user determines a computing task (e.g., repairing a 3D model mesh) and a running environment (e.g., a personal computer for prototyping), the user may use the CMS unit to select appropriate modules and datasets for the computing task.

As shown in FIG. 7, the CMS unit proposes various project license options, which may be viewed as trees and presented on a display screen. Once a project license is selected, i.e., a license selection tree is chosen by the user, the CMS unit may start at the top of the license selection tree and move down, based on combination possibilities of licenses described earlier (e.g., using the license compliance graph shown in FIG. 6). The CMS unit may assess compatibility based on the linking, modification, and re-licensing requirements.

For example, if the user selects lesser general public license (LGPL), the CMS unit may start from the top of the tree and first ascertain whether the LGPL code is statically linked. If the answer is yes, the CMS unit or the user must provide a way to replace the library (or re-license). If the answer is no, it is compatible with non-GPL code (permissive). The CMS unit then ascertains whether the LGPL code is dynamically linked. If the answer is yes, it is compatible with most licenses. If the answer is no, it might need to re-license.

A computing task may be fulfilled with various modules and datasets. For example, in a 3D model mesh repair task, tools like CGAL (e.g., under GPL, LGPL, or commercial licenses) and Geogram (e.g., under BSD-3 license) may be utilized. Users may also develop their own programs to add to the CMS unit. These tools, despite varying licenses, may be used to execute the same task, though their computational cost or repair quality may differ. As license complexity may hinder software development and deployment, there exists a need for a structured approach to manage the licenses. The structured approach involves evaluating compatibility of different licenses and grouped modules and dataset that are formed based on their respective licenses, such as permissive, weakly protective, strongly protective, and network protective. It may improve secure and compliant usage of software resources.

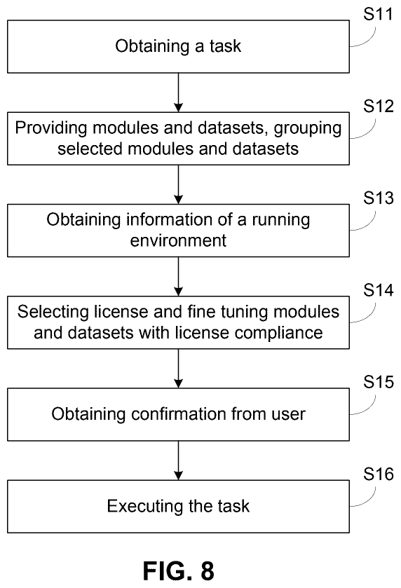

FIG. 8 illustrates a schematic flow chart of a task execution process according to embodiments of the present disclosure. The system 100 illustrated above may be used to develop and deploy modules and datasets, execute one or more actions through the execution unit, asset unit, and CMS unit. Assuming the system 100 is installed at a personal computer and the execution unit, asset unit, and CMS unit of the system 100 are hosted at the personal computer.

At S11, a user opens an interface of the CMS unit through a display of the computer. The CMS unit presents multiple computing tasks in the interface. The user selects a task via the interface of the CMS unit. The CMS unit obtains information of the task after the user makes the selection. The task may be, for example, a 3D model mesh repair.

At S12, the CMS unit retrieves modules and datasets that are available and related to the task from the system 100. Optionally, the CMS unit may provide a list of the modules and datasets and present the list to the user via the interface of the CMS unit. The user may search and select appropriate modules and datasets from the list. The CMS unit may organize the selections using breadth first search (BFS) or other grouping methods to group the selected modules and datasets based on the license types, such as GPL, BSD, or proprietary license. The grouping method is illustrated in more details in descriptions below.

At S13, the user selects a running environment via the interface. The running environment may be local, e.g., the task may be executed via the personal computer, another computer, or a server installed locally. As aforementioned, the running environment may also be cloud based, which utilizes remote computing resources. The CMS unit obtains information of the running environment after the user makes the selection or enters the information. In some cases, a local running environment is preferred for prototyping.

At S14, one or more licenses for the task are selected by the user or the CMS unit. Based on the selected licenses, the CMS unit may fine tune the selected modules and datasets. After the license is selected, the CMS unit may perform an evaluation process by starting at the top of a corresponding license selection tree (e.g., one of the license selection trees as shown in FIG. 7). The CMS unit then may move down to the bottom of the tree. The CMS unit may evaluate compatibility scenarios according to the linking, modification, and re-licensing requirements. Optionally, the license compliance graph shown in FIG. 6 may also be used. As such, the components (e.g., modules and datasets) may adhere to the legal and operational standards.

At S15, the CMS unit obtains a confirmation from the user. The confirmation indicates the user approves the selected modules and datasets. In addition, the confirmation also indicates the user approves the selected license.

At S16, after the license compliance issues are addressed, the system 100 executes the task using the selected modules, datasets, running environment, and licenses.

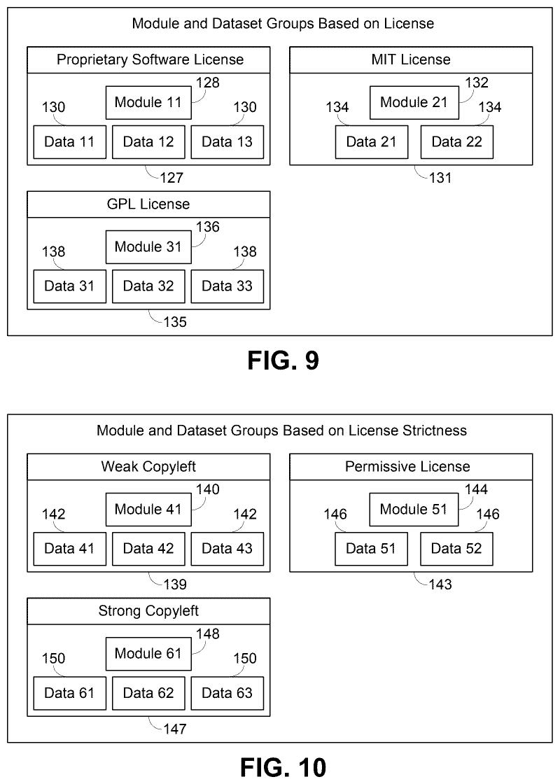

FIGS. 9, 10, and 11 illustrate block diagrams of module and dataset groups based on license, license strictness, and computing environment respectively according to embodiments of the present disclosure. As illustrated above, software components including modules and datasets are subject to licensing requirements. Certain proprietary software may be distributed and operated with great flexibility, whether on personal computers, public cloud platforms, or in private clouds. Permissive open-source licenses such as MIT offer similar flexibility to that of some proprietary software, while GPL may be suitable for backend services, like software as a service (SAAS), if the software is not made available publicly.

In some embodiments, grouping may be implemented at a CMS unit (e.g., the CMS unit 106 shown in FIG. 1), which maintains relationships among modules, among datasets, and among modules and datasets. Additionally, graph data structures predefined and adaptively updated may be utilized to facilitate analyzing and search algorithms. They can be breadth-first search (BFS), depth-first search (DFS), or combinations thereof with other methods, such as priority queues, for computing performance and legal regulations. Search methods may be optimized in terms of various conditions with more details below.

In some embodiments, a task encompasses independent modules and datasets. The modules and datasets may be grouped according to license information. As shown in FIG. 9, groups 127, 131, and 135 are formed based on proprietary software license, MIT license, and GPL, respectively. Group 127 includes a module 128 (e.g., module 11) and one or more datasets 130 (e.g., Data 11, 12, and 13). Group 131 includes a module 132 (e.g., module 21) and one or more datasets 134 (e.g., Data 21 and 22). Group 135 includes a module 136 (e.g., module 31) and one or more datasets 138 (e.g., Data 31, 32, and 33). Such a grouping method allows for flexible software distribution without exposing proprietary information or trade secrets. The groups may be deployed and executed flexibly on personal computers or in cloud environments with reduced license complexity, thereby enhancing security and privacy protection.

Further, as shown in FIG. 10, the modules and datasets may also be grouped specifically according to license strictness. For example, groups 139, 143, and 147 are formed based on weak copyleft, permissive license, and strong copyleft, respectively. Exemplarily, group 139 includes a module 140 (e.g., module 41) and one or more datasets 141 (e.g., Data 41, 42, and 43). Group 143 includes a module 144 (e.g., module 51) and one or more datasets 146 (e.g., Data 51 and 52). Group 147 includes a module 148 (e.g., module 61) and one or more datasets 150 (e.g., Data 61, 62, and 63). Thus, the modules and datasets may be grouped into permissive, weakly protective, and strongly protective categories. In some other cases, an additional group may be created for a network protective category when there are a module and datasets that require such license compliance. It further enhances the capabilities, security, and privacy protection.

After the modules and datasets are grouped according to license or license strictness, the groups may be stored, e.g., by the system 100 or the CMS unit of the system 100. Optionally, the system 100 may store some or all of the modules and datasets (or the above-mentioned selected modules and datasets) in respective groups in the system, such as the groups shown in FIGS. 9 and 10. It may make retrieval of the modules and datasets more efficient.

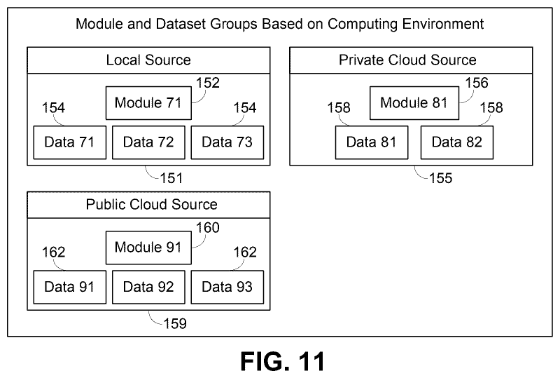

Moreover, as shown in FIG. 11, the modules and datasets may also be grouped specifically according to the computing environment. For example, groups 151, 155, and 159 are formed based on local computing source, private cloud source, and public cloud source, respectively. Exemplarily, group 151 includes a module 152 (e.g., module 71) and one or more datasets 154 (e.g., Data 71, 72, and 73). Group 155 includes a module 156 (e.g., module 81) and one or more datasets 158 (e.g., Data 81 and 82). Group 159 includes a module 160 (e.g., module 91) and one or more datasets 162 (e.g., Data 91, 92, and 93).

The local computing source may be based on personal devices (or a local server) and may be arranged for executing sensitive operations. Thus, data privacy may be maintained and dependency on cloud-based services may be reduced. It is suitable for tasks involving confidential data that may be better protected in a controlled and secure local environment.

The private and public cloud computing sources may be in need when higher processing power is required or computationally intensive tasks are executed. The tasks may be offloaded to the private or public cloud. Thus, the computing sources become scalable and performance of demanding applications may be enhanced. Further, compared to limitations of local computing sources, the cloud may provide more power when needed with flexibility and scalability.

As the modules and datasets may be deployed either in local or cloud computing environment, the CMS unit of the system 100 may be arranged, e.g., through executing certain algorithms, to group the modules and datasets based on the licensing and computing requirements. It may provide an optimal computing strategy that balances security, privacy, efficiency, and performance.

Further, the system 100 may include an intelligent compute switching mechanism. The switching mechanism may be used by the CMS unit to dynamically optimize resource utilization and switch between an execution environment (e.g., local environment) and another execution environment (e.g., cloud-based environment). For example, real-time conditions of the local and cloud-based execution environments may be detected and examined by the CMS unit via the switching mechanism. The CMS unit may check factors such as current workload, network availability, and cost-efficiency to decide whether a task should be run locally or offloaded to the cloud. Exemplarily, the CMS unit (or system 100) may deploy the modules and datasets flexibly across the computing environments. Optionally, a user may also utilize the CMS GUI interface or command line interface to allocate module and dataset groups in diverse computing environments. The CMS unit may coordinate the allocation such that tasks may be executed seamlessly across different platforms. Thus, the system 100 may be configured as a flexible computing platform that may dynamically select an execution environment based on security, privacy, cost, performance factors, as well as license compliance and patent constraint.

Although the description above contains many embodiments, these should not be viewed as limiting the scope of the invention but should instead be understood as merely providing illustrations of some of the presently preferred embodiments. Numerous modifications will be obvious to those skilled in the art. The above description of the disclosed embodiments enables those skilled in the art to implement or use this application. The general principles defined herein may be applied to other embodiments without departing from the spirit or scope of this application. Therefore the scope of the invention should be determined by the appended claims and their legal equivalents, rather than by the embodiments and examples given.

We claim:

1. A method comprising:
obtaining a software package, the software package including a plurality of code segments and a plurality of data segments;
searching the plurality of code segments and the plurality of data segments for license information;
obtaining license information of the plurality of code segments and the plurality of data segments;
generating a plurality of code modules and a plurality of datasets from the plurality of code segments and the plurality of data segments;
attaching a plurality of snippets to the plurality of code modules and the plurality of datasets; and
forming a plurality of snippet-attached modules and a plurality of snippet-attached datasets from the plurality of code modules and the plurality of datasets, each of the plurality of snippet-attached modules and plurality of snippet-attached datasets including a corresponding snippet from the plurality of snippets, the plurality of snippets making the plurality of snippet-attached modules executable and the plurality of snippet-attached datasets become formatted or repackaged, respectively.

2. The method according to claim 1, further comprising generating the plurality of snippets for the plurality of code modules and the plurality of datasets.

3. The method according to claim 1 wherein attaching the plurality of snippets to the plurality of code modules and the plurality of datasets includes attaching the plurality of snippets to at least a majority of the plurality of code modules and the plurality of datasets.

4. The method according to claim 1, further comprising decomposing the software package into the plurality of code segments and the plurality of data segments.

5. The method according to claim 1, further comprising executing a task using the plurality of snippet-attached modules and plurality of snippet-attached datasets.

6. The method according to claim 5, further comprising switching between a computing environment and another computing environment through a switching mechanism when the task is executed.

7. The method according to claim 1, further comprising grouping the plurality of snippet-attached modules and plurality of snippet-attached datasets according to information of license or information of computing environment.

8. A method comprising:
obtaining a task;
selecting a plurality of code modules and a plurality of datasets, at least a majority of the plurality of code modules and plurality of datasets each including a snippet, and the snippet making one code module of the at least a majority of the plurality of code modules and plurality of datasets executable or making one dataset of the at least a majority of the plurality of code modules and plurality of datasets formatted or repackaged;
grouping the plurality of code modules and the plurality of datasets according to license information; and
executing the task using the plurality of code modules and plurality of datasets.

9. The method according to claim 8, further comprising obtaining information of a computing environment for executing the task.

10. The method according to claim 9, further comprising fine tuning the plurality of code modules and the plurality of datasets after obtaining the information of the computing environment.

11. The method according to claim 8, further comprising selecting a license for the task.

12. The method according to claim 8 wherein the plurality of code modules and the plurality of datasets are selected according to information of license.

13. The method according to claim 8, further comprising obtaining a confirmation from a user after the plurality of code modules and plurality of datasets are selected.

14. The method according to claim 8, further comprising switching between a computing environment and another computing environment through a switching mechanism when the task is executed.

15. A computing system, comprising:
an execution unit for executing a task;
a data storage and management unit;
a content management system (CMS) unit;
a plurality of code modules; and
a plurality of datasets, wherein the plurality of code modules and the plurality of datasets include a plurality of snippets, and the plurality of snippets makes at least part of the plurality of code modules executable and makes at least part of the plurality of datasets formatted or repackaged.

16. The system according to claim 15 wherein at least a majority of the plurality of code modules and the plurality of datasets each include one of the plurality of snippets.

17. The system according to claim 15 wherein the plurality of code modules and the plurality of datasets are grouped according to license information or a computing environment.

18. The system according to claim 15, further comprising a switching mechanism for switching between a computing environment and another computing environment when a task is executed.

19. The system according to claim 15 wherein the plurality of code modules and the plurality of datasets are obtained from a plurality of code segments and a plurality of data segments of a software package through a decomposing process.

20. The system according to claim 15 wherein the plurality of snippets is arranged to wrap the plurality of code modules and the plurality of datasets or compile code of the plurality of code modules and the plurality of datasets.
